(19) United States
(12) Patent Application Publication
(10) Pub. No.: US 2004/0067336 A1
(43) Pub. Date: Apr. 8, 2004

(54) Curb mat

(76) Inventor: H. Alexander Munroe II, Wilmington, NC (US)

Correspondence Address: WILLIAM J. MASON, MACCORD MASON PLLC, POST OFFICE BOX 1489, WRIGHTSVILLE BEACH, NC, 28480, US

(21) Appl. No.: 10/616,543

(22) Filed: Jul. 10, 2003

Related U.S. Application Data
(60) Provisional application No. 60/395,759, filed on Jul. 12, 2002.

(51) Int. Cl. B32B 3/10

(52) U.S. Cl. 428/131

(57) ABSTRACT

The present invention relates to detectable warning surfaces for the visually impaired. In particular, the present invention addresses the difficulties encountered during installation of prior art warning surfaces by providing a novel tactile warning surface that is easy and quick to install. Specifically, the invention is a roll-up mat having a tactile warning surface. The mat is referred to as a roll-up mat because it is flexible enough to be rolled into a cylindrical bundle for easy handling during transport and installation. The mat has top and bottom surfaces, a top end, a bottom end, parallel sides and beveled edges. A plurality of tactile warning elements are integrated into the top surface. Preferably, the tactile warning elements are a rectangular array of truncated raised domes, and are aligned in horizontal rows and vertical columns. The beveled edges slope from the top surface down to the bottom surface. The beveled edges have a plurality of holes along the edge of the mat. The holes serve as guides for the installation of anchors that hold the mat to a walkway surface. The bottom surface of the mat can have an adhesive for additional strength for adhering to a walkway surface.

### BACKGROUND OF THE INVENTION

(1) Field of the Invention

The present invention relates generally to detectable warning surfaces for the visually impaired. The invention is particularly useful for adding a warning surface to a new or previously constructed sidewalk curb.

(2) Description of the Prior Art

Tactile warning surfaces for the visually impaired are required by law to be installed in specified public places. In particular, the required tactile warning surfaces include walkway surfaces that provide tactile warning adjacent to the intersection of vehicular areas and curb ramps. As a visually impaired person steps from a normal walkway surface onto a tactile warning surface, they notice a change in texture from one surface to the other warning them of the hazardous area that they are entering.

Prior art warning surfaces are constructed by methods involving surface forming, etching, deposition and tiling. Surface forming requires the warning surface to be created during the construction of a new walkway surface. One such surface forming method stamps wet concrete with a stamp that leaves a patterned imprint that cures into a tactile warning surface. This method may be preferable in some instances, but is an impractical method for adding a tactile warning surface to a previously constructed walkway surface. Etching methods require the precise removal of walkway surface material creating a uniform tactile warning surface. Etching typically requires the use of abrasive cutting tools, resulting in undesirable amounts of noise and dust. Deposition methods require the formulation of composite materials such as epoxy and glass fibers. The composite material is deposited onto walkway surfaces in individual drops that cure into dome shaped bumps. The drops of composite material are metered out in a pattern of equally spaced bumps creating a tactile surface. However, the deposition process requires significant skill to implement and often results in a surface covered in bumps that are not uniform in height resulting in a stumbling hazard. Another tactile warning surface and method involves adhering tactile tiles to a previously constructed walkway surface in a process that is lengthy and specialized. What is needed is a novel tactile warning surface that can be installed quickly requiring little skill. The novel tactile warning surface should also be applicable to both new and previously constructed walkway surfaces.

### SUMMARY OF THE INVENTION

The present invention relates to detectable warning surfaces for the visually impaired. In particular, the present invention addresses the difficulties encountered during installation of prior art warning surfaces by providing a novel tactile warning surface that is easy and quick to install. Moreover, the tactile warning surface of the present invention requires very little skill to install properly.

Specifically, the invention is a roll-up mat having a tactile warning surface. The mat is referred to as a roll-up mat because it is flexible enough to be rolled into a cylindrical bundle for easy handling during transport and installation. The mat has top and bottom surfaces, a top end, a bottom end, parallel sides and beveled edges. The beveled edges are about one inch wide and slope from the top surface down to the bottom surface. The beveled edges have a plurality of holes along the edge of the mat. Preferably each puncture has a diameter of around one-eighth inch. The holes serve as guides for the installation of anchors that hold the mat to a walkway surface. The bottom surface of the mat can have an adhesive for additional strength for adhering to a walkway surface.

The top surface of the mat includes a rectangular array of raised domes aligned in horizontal rows and vertical columns. The array of raised domes preferably extends horizontally and vertically to within two inches of the mat's perimeter. The horizontal rows of raised domes extend parallel to the width of the mat. Preferably, the center-to-center spacing of individual rows of raised domes and columns of raised domes is equal, being around 2.35 inches. It is also preferred that each raised dome be truncated with a nominal height of 0.2 inches and a nominal diameter of 0.9 inches. The top surface also includes uniform scoring or raised strips with grooves to increase overall slip resistance. Sandblasting the mold used to manufacture the mats can create the scoring. Raised strips are also useful in decreasing the height differential between the domes and the mat, thereby making it easier for the elderly and people with shopping carts to walk over the mat.

The length and width dimensions of the mat of the present invention are carefully controlled to allow quick and easy installation onto walkway surfaces that intersect curb ramps and curb cuts. Government regulations dictate that a curb cut must be at least thirty-six inches wide. Furthermore, the raised domes must be within at least two inches of the mat's perimeter. Combining these constraints yields a mat width dimension of forty inches.

Also by regulation, the running slope of a curb ramp must not be steeper than a one to twelve grade. The rise of the curb is six inches maximum. Therefore, for each one-inch rise in the curb ramp, the tactile warning surface must run twelve inches in length. In order to cover the maximum curb rise, the array of domes needs to be seventy-two inches in length. An additional two inches between the array of raised domes and each end of the mat results in a mat length dimension of seventy-six inches. In some cases, such as along wide curb ramps, several mats of the present invention may need to be cut and placed alongside each other to completely cover the ramp. Therefore, to make installation easier, a guide line can be added to the bottom of the mat making it easier to trim the mat square. The guide line can be printed ink or molded into the mat during manufacture. Moreover, the guide line can be perforated to facilitate cutting during separation.

The mat can be made from recycled tire-cord. Nylon fibers making up the tire-cord strengthen the mat. An added benefit of using recycled material is that the government, in many instances, favors products that include recycled materials.

Curb mat installation begins with the installation site delivery of a curb mat rolled-up into a cylindrical bundle. Once the mat is placed near a walkway substrate to be covered, the curb mat can be unrolled. Next, the installer precisely positions the mat on top of the walkway substrate such that the edges of the mat are properly aligned with a predetermined walkway path. The installer then fastens anchors through the beveled edges' perforations and into the walkway substrate to anchor the mat to the walkway substrate. If the adhesive backed embodiment of the curb mat is used, the adhesive is allowed to dry before the curb mat is used as a walkway surface.

In some cases, a number of mats will need to be cut to a specific dimension in order to cover a specified area. To make for easier installation, the installer can use the guide line on the mat's bottom surface as a template for cutting the mat to a different dimension. The guide line indicates the specific dimensions to follow when placing multiple mats either side-by-side or end-to end.

### BRIEF DESCRIPTION OF THE DRAWINGS

FIG. 1 is a plan view of the curb mat of the present invention.

FIG. 2 is a partial cross sectional edge view of the curb mat of the present invention.

### DETAILED DESCRIPTION OF THE INVENTION

In the following description, terms such as horizontal, upright, vertical, above, below, beneath, and the like, are used solely for the purpose of clarity in illustrating the invention and should not be taken as words of limitation. The drawings are for the purpose of illustrating the invention and are not intended to be to scale.

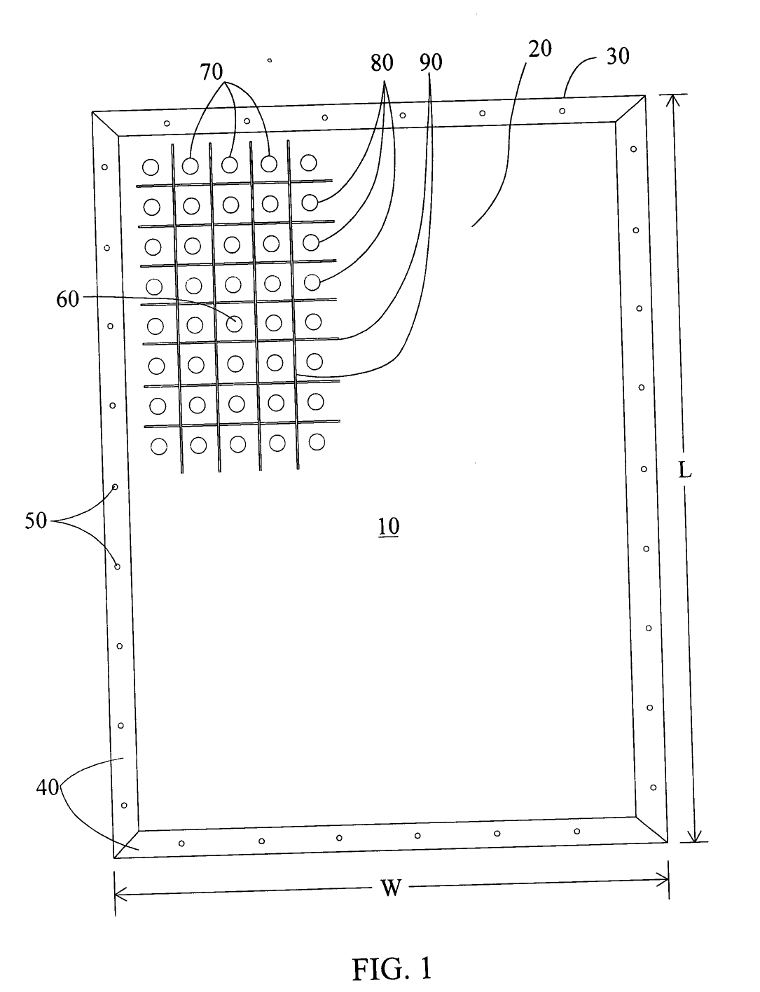

Referring to the drawings and first to FIG. 1, a curb mat 10 comprises a top surface 20 and a bottom surface 30. Beveled edges 40 are about one inch in width and slope from top surface 20 down to bottom surface 30. A plurality of holes 50 align within beveled edges 40. Preferably, each of holes 40 has a diameter of around one-eighth of an inch.

Top surface 20 includes a rectangular array of truncated raised domes 60 aligned in horizontal rows 70 and vertical columns 80. Horizontal rows 70 extend to within two inches or less of mat 10's perimeter. Similarly, vertical columns 80 extend to within two inches or less of mat 10's perimeter. Preferably, the center-to-center spacing of individual domes in array 60 is equidistant, having a range of between two and three inches. The preferred length L of mat 10 is seventy-six inches and the preferred width W is forty inches. A plurality of raised strips 90 running between the columns and rows of domes decrease the height differential between the domes and the mat, making it easier for elderly people and shopping carts to negotiate the mat.

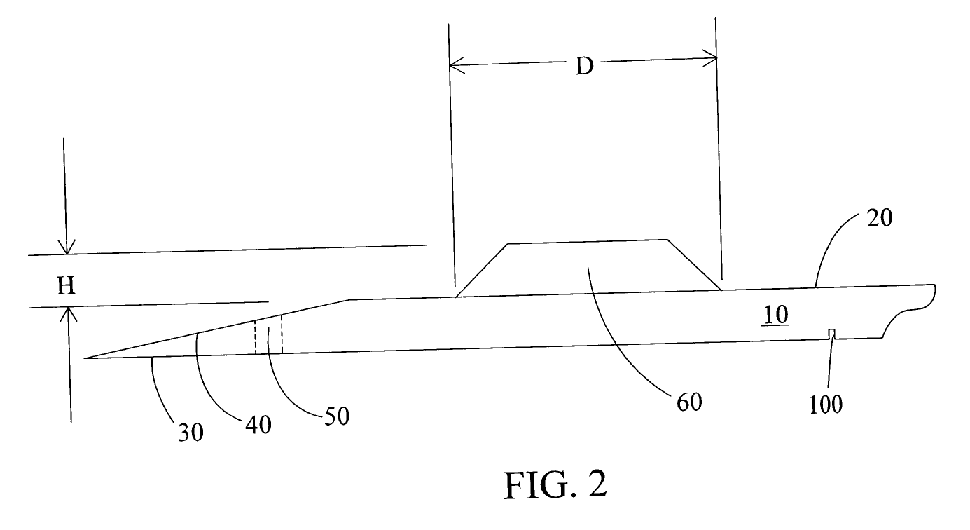

Referring now to FIG. 2, mat 10 is seen in cross section from one edge. A dome 60 has a diameter D and a height H. Nominally, H is about two tenths of an inch and D is about nine tenths of an inch. Another feature is a guide line cut 100 for making it easier to trim the mat square.

Certain modifications and improvements will occur to those skilled in the art upon reading the foregoing description. It should be understood that all such modifications and improvements have been deleted herein for the sake of conciseness and readability but are properly within the scope of the following claims.

What is claimed is:

1. A quick installing tactile warning surface for the visually impaired comprising:
a) a roll-up mat having top and bottom surfaces, a top end, a bottom end, parallel sides and beveled edges; and
b) a plurality of tactile warning elements integral with said top surface.

2. The warning surface of claim 1, wherein said roll-up mat is flexible enough to be rolled into a cylindrical bundle for handling and transport.

3. The warning surface of claim 1, wherein said beveled edges include a plurality of aligned and spaced holes along said mat edges, said holes being useable as guides for the installation of anchors used to hold said mat to a walkway surface.

4. The warning surface of claim 1, wherein said plurality of tactile warning elements is a rectangular array of raised domes aligned in horizontal rows and vertical columns.

5. The warning surface of claim 1, wherein said mat bottom surface includes an adhesive for additional strength for adhering to a walkway surface.

6. The warning surface of claim 1, wherein said roll-up mat is made from recycled tire-cord.

7. The warning surface of claim 1, wherein said top surface also includes uniform scoring to increase overall slip resistance.

8. The warning surface of claim 7, whereby sandblasting a mold used to manufacture said mat creates said uniform scoring.

9. The warning surface of claim 1, wherein said top surface includes raised strips to increase overall slip resistance.

10. The warning surface of claim 1, wherein said bottom surface includes a guide line for making it easier to squarely trim said mat.

11. The warning surface of claim 10, wherein said guide line is printed with ink.

12. The warning surface of claim 10, wherein said guide line is molded into said bottom surface.

13. A quick installing tactile warning surface for the visually impaired comprising:
a) a roll-up mat having top and bottom surfaces, a top end, a bottom end, parallel sides and beveled edges, said mat being flexible enough to be rolled into a cylindrical bundle for easy handling during transport and installation; and
b) a plurality of tactile warning elements integrated into said top surface.

14. The warning surface of claim 13, wherein said beveled edges include a plurality of aligned and spaced holes along said mat edges, said holes being useable as guides for the installation of anchors used to hold said mat to a walkway surface.

15. The warning surface of claim 13, wherein said plurality of tactile warning elements is a rectangular array of truncated raised domes aligned in horizontal rows and vertical columns.

16. The warning surface of claim 15, wherein said top surface includes raised strips between said horizontal rows and vertical columns to increase overall slip resistance.

17. A quick installing tactile warning surface for the visually impaired comprising:
a) a roll-up mat having top and bottom surfaces, a top end, a bottom end, parallel sides and beveled edges, said mat being flexible enough to be rolled into a cylindrical bundle for easy handling during transport and installation; and
b) a rectangular array of truncated raised domes integral to said top surface, said domes being aligned in horizontal rows and vertical columns.

18. The warning surface of claim 17, wherein said mat bottom surface includes an adhesive for additional strength for adhering to a walkway surface.

19. The warning surface of claim 17, wherein said mat top surface includes raised strips between said horizontal rows and vertical columns to increase overall slip resistance.

20. The warning surface of claim 17, wherein said beveled edges include a plurality of aligned and spaced holes along said mat edges, said holes being useable as guides for the installation of anchors used to hold said mat to a walkway surface.
